(19) United States
(12) Patent Application Publication
(10) Pub. No.: US 2015/0007785 A1
(43) Pub. Date: Jan. 8, 2015

(54) ENGINE AND SADDLE TYPE VEHICLE

(71) Applicant: YAMAHA HATSUDOKI KABUSHIKI KAISHA, Iwata-shi (JP)

(72) Inventors: Tadakatsu HOSOKAWA, Shizuoka (JP); Kazuyuki MAEDA, Shizuoka (JP)

(21) Appl. No.: 14/316,846

(22) Filed: Jun. 27, 2014

(30) Foreign Application Priority Data
Jul. 2, 2013 (JP) 2013-139309

(51) Int. Cl. F02F 1/14; F02B 61/02; F02F 1/24

(52) U.S. Cl. CPC F02F 1/14; F02F 1/242; F02B 61/02
USPC 123/41.79

(57) ABSTRACT

An engine includes a piston and a casing including a cylinder. The cylinder and the piston define a combustion chamber. The casing includes an intake port, a plurality of exhaust ports, a spark plug hole, a drainage hole, and a water jacket. The spark plug hole extends to the combustion chamber. A spark plug is housed in the spark plug hole. The drainage hole extends from the spark plug hole. The water jacket includes a central passage and an inter-port passage. The central passage is located near the spark plug hole. The inter-port passage extends to the central passage. The inter-port passage is arranged between the plurality of exhaust ports. The inter-port passage is located between the drainage hole and the cylinder in a central axis direction of the spark plug hole.

### BACKGROUND OF THE INVENTION

1. Field of the Invention

The present invention relates to an engine and saddle type vehicle provided with a water jacket.

2. Description of the Related Art

A known engine is traditionally provided with a spark plug hole extending to a combustion chamber, a drainage hole extending to the spark plug hole, and two exhaust ports extending to the combustion chamber (refer to, for example Japan Laid-open Patent Application Publication No. 2004-270457). In Japan Laid-open Patent Application Publication No. 2004-270457, the drainage hole is located between the two exhaust ports.

In the engine described in Japan Laid-open Patent Application Publication No. 2004-270457, a water jacket is configured to be clear of the two exhaust ports. More specifically, the water jacket is not located between the two exhaust ports where the drainage hole passes through. Therefore, it tends to be difficult to improve the efficiency of cooling of the engine in Japan Laid-open Patent Application Publication No. 2004-270457.

### SUMMARY OF THE INVENTION

With the above-described situation in mind, preferred embodiments of the present invention provide an engine and saddle type vehicle with improved cooling efficiency.

An engine according to a first aspect of a preferred embodiment of the present invention is provided with a piston and a casing including a cylinder. The cylinder houses the piston. The cylinder and the piston define a combustion chamber. The casing includes an intake port, a plurality of exhaust ports, a spark plug hole, a drainage hole, and a water jacket. The intake port extends to the combustion chamber. Intake air is introduced into the combustion chamber through the intake port. The plurality of exhaust ports extend from the combustion chamber. Exhaust air is expelled from the combustion chamber through the plurality of exhaust ports. The spark plug hole extends to the combustion chamber. A spark plug is housed in the spark plug hole. The drainage hole extends from the spark plug hole. Coolant circulates in the water jacket. The water jacket includes a central passage and an inter-port passage. The central passage is located near the spark plug hole. The inter-port passage extends to the central passage. The inter-port passage is arranged between the plurality of exhaust ports. The inter-port passage is located between the drainage hole and the cylinder in a central axis direction of the spark plug hole.

The engine according to a second aspect of a preferred embodiment of the present invention preferably includes the features of the first aspect wherein the spark plug includes a reach portion. The reach portion includes a screw thread provided on at least one portion of an outer peripheral surface of the reach portion. The spark plug hole includes a mounting hole portion extending to the combustion chamber. The reach portion of the spark plug is threaded on at least one portion of an inner surface of the mounting hole portion. The central passage is located near the mounting hole portion of the spark plug hole.

The engine according to a third aspect of a preferred embodiment of the present invention preferably includes the features of the second aspect wherein the spark plug hole includes a flange insertion portion extending to the mounting hole portion. The flange of the spark plug is inserted in the flange insertion portion. The inter-port passage is located between the flange insertion portion and the cylinder in the central axis direction.

The engine according to a fourth aspect of a preferred embodiment of the present invention preferably includes the features of the third aspect wherein a distance between the central passage and the central axis is smaller than a distance between an inner surface of the flange insertion portion and the central axis in a radial direction perpendicular or substantially perpendicular to the central axis.

The engine according to a fifth aspect of a preferred embodiment of the present invention preferably includes the features of the first through fourth aspects wherein the water jacket includes an outer passage extending to the inter-port passage. The outer passage is located farther away from the central axis than the inter-port passage in the radial direction perpendicular or substantially perpendicular to the central axis.

The engine according to a sixth aspect of a preferred embodiment of the present invention preferably includes the features of the first, second, fourth and fifth aspect wherein the drainage hole extends between the plurality of exhaust ports.

The engine according to a seventh aspect of a preferred embodiment of the present invention preferably includes the features of the sixth aspect wherein the spark plug hole includes a flange insertion portion extending to the mounting hole portion. A flange of the spark plug is inserted in the flange insertion portion. The drainage hole includes an inlet in the flange insertion portion of the spark plug hole.

The engine according to an eighth aspect of a preferred embodiment of the present invention preferably include the features of the sixth or seventh aspect wherein the drainage hole includes an outlet located closer to the cylinder than a center position of an exit of the plurality of exhaust ports in the central axis direction.

The engine according to a ninth aspect of a preferred embodiment of the present invention preferably include the features of the first through eighth aspect wherein a length of the mounting hole portion is no less than two times an inner diameter of the mounting hole portion.

The engine according to a tenth aspect of a preferred embodiment of the present invention preferably includes the features of the first through ninth aspect wherein the central passage surrounds an entire perimeter of the spark plug hole.

The engine according to an eleventh aspect of a preferred embodiment of the present invention preferably includes the features of the first through tenth aspects wherein the inter-port passage overlaps with the drainage hole when viewed from a top of the engine.

A saddle type vehicle according to a twelfth aspect of a preferred embodiment of the present invention includes an engine according to any one of the first through eleventh aspects.

In the engine according to the first aspect of a preferred embodiment of the present invention, the drainage hole and the inter-port passage are closely arranged to each other to realize efficient cooling of the cylinder by providing the inter-port passage between the plurality of exhaust ports. Further, given that the inter-port passage is connected to the central passage, it is possible to prevent air from collecting in the inter-port passage. Therefore, the efficiency of cooling the cylinder is improved.

In the engine according to the second aspect of a preferred embodiment of the present invention, the central passage is located near to the spark plug hole at the section closest to the cylinder, thus further improving the efficiency of cooling the cylinder.

In the engine according to the third aspect of a preferred embodiment of the present invention, the inter-port passage is brought even closer to the cylinder, and thus the cooling efficiency of the cylinder is improved.

In the engine according to the fourth aspect of a preferred embodiment of the present invention, the central passage is extended towards the center of the cylinder, thus the cooling efficiency of the cylinder is further improved.

In the engine according to the fifth aspect of a preferred embodiment of the present invention, the inter-port passage communicates with the central passage and a first outer passage, thus preventing air from collecting in the inter-port passage.

In the engine according to the sixth aspect of a preferred embodiment of the present invention, the drainage hole and the inter-port passage are arranged side-by-side between the plurality of exhaust ports, thus bringing the inter-port passage closer to the cylinder and improving the cooling efficiency of the cylinder.

In the engine according to the seventh aspect of a preferred embodiment of the present invention, moisture is efficiently drained from the portion of the spark plug hole where moisture especially tends to collect.

In the engine according to the eighth aspect of a preferred embodiment of the present invention, when viewed from a side of the engine, the drainage hole appears to be arranged intersecting with the exhaust port, thus compactly arranging the drainage hole.

In the engine according to the ninth aspect of a preferred embodiment of the present invention, a large amount of space is secured for the central passage and the inter-port passage, thus the central passage and the inter-port passage have large inner diameters. As a result, the efficiency of cooling the cylinder is improved.

In the engine according to the tenth aspect of a preferred embodiment of the present invention, the cooling efficiency located near the center of the cylinder is further improved.

In the engine according to the eleventh aspect of a preferred embodiment of the present invention, the inter-port passage and the drainage hole are compactly arranged.

In the saddle type vehicle according to the twelfth aspect of a preferred embodiment of the present invention, the drainage hole and the inter-port passage are compactly arranged, thus obtaining effective cooling of the cylinder by providing the inter-port passage between the plurality of exhaust ports. Further, given that the inter-port passage is connected to the central passage, it is possible to prevent air from collecting in the inter-port passage. Therefore, the efficiency of cooling the cylinder is improved.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a cross-sectional view of major portions of an engine.

FIG. 2 is a schematic diagram showing a configuration in the hollow section of the cylinder head.

FIG. 3 is a schematic diagram showing a configuration of the water jacket.

FIG. 4 is a cross-sectional view along the A-A in FIG. 1.

FIG. 5 is a left side view of a saddle type vehicle.

FIG. 6 is a cross-sectional view of major portions of the engine.

### DETAILED DESCRIPTION OF THE PREFERRED EMBODIMENTS

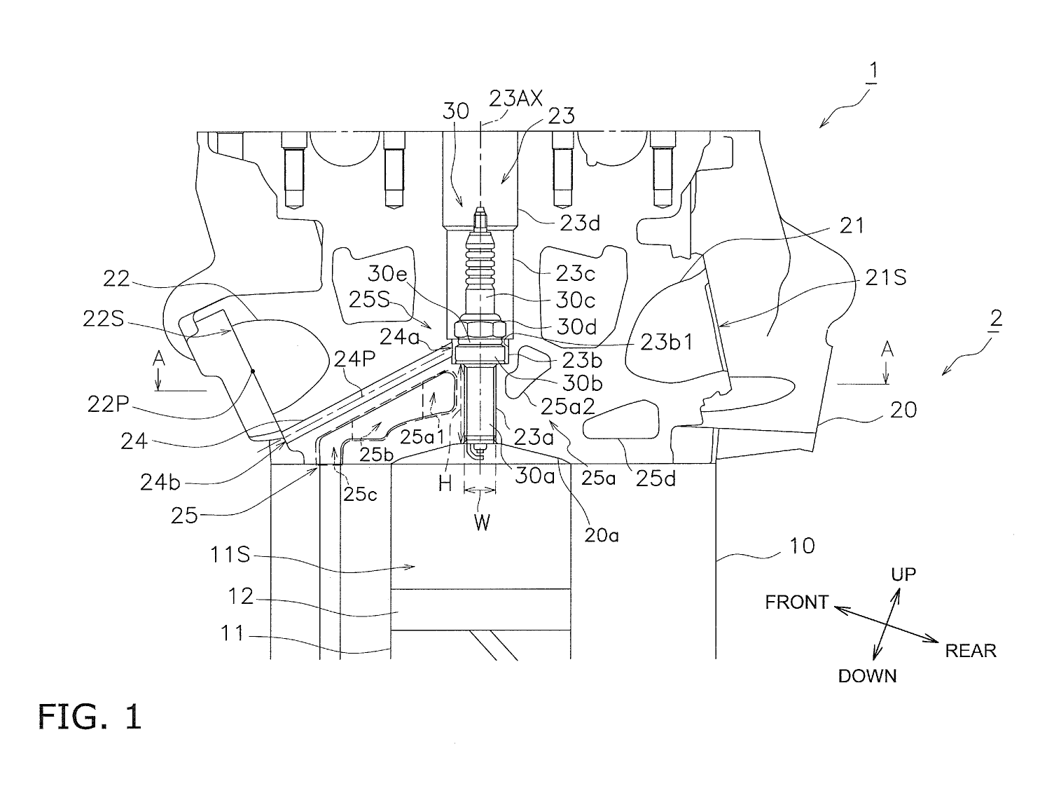

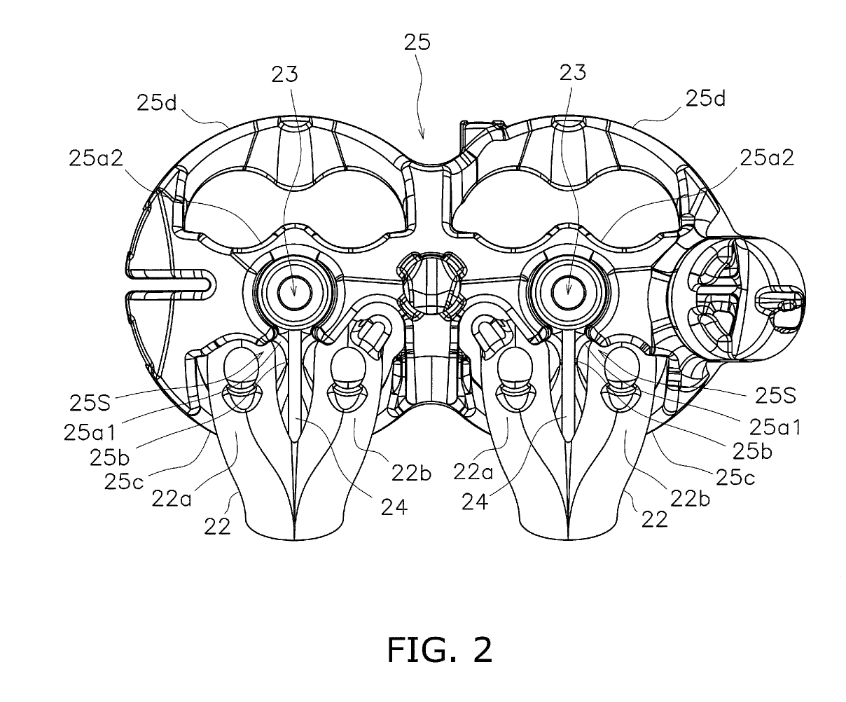

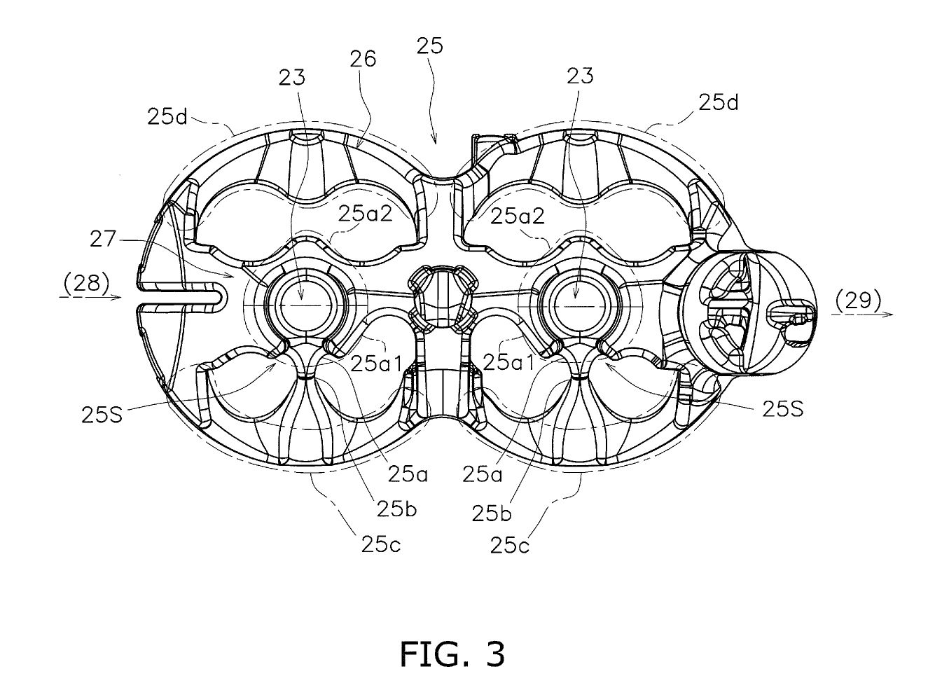

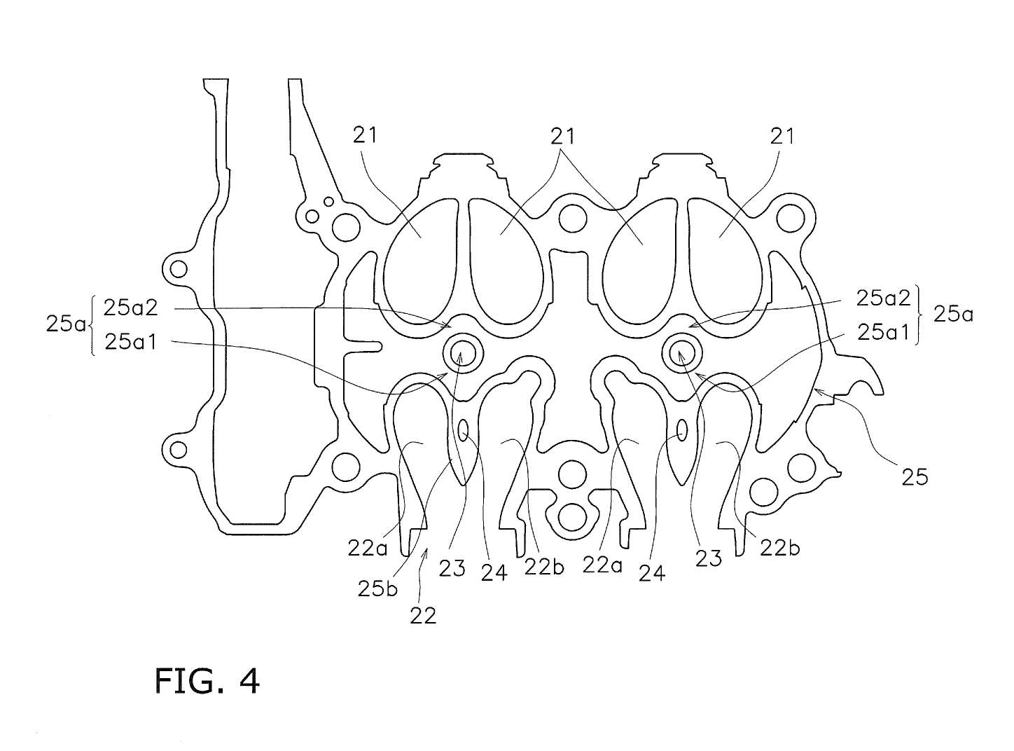

An overall configuration of an engine 1 according to preferred embodiments of the present invention will be described with reference to the drawings. FIG. 1 is a cross-sectional view of major portions of the engine 1. The cylinder head cover is omitted from FIG. 1. FIG. 2 is a schematic diagram showing a configuration in the hollow section of the cylinder head 20. The intake port 21 is omitted from FIG. 2. FIG. 3 is a schematic diagram showing a configuration of the water jacket 25. FIG. 4 is a cross-sectional view along the line A-A in FIG. 1.

The engine 1 is preferably included in a saddle type vehicle such as motorcycle, an all-terrain vehicle, a snowmobile, or the like. The engine 1 according to the present preferred embodiment preferably is a four-valve DOHC two-cylinder four-stroke engine, for example. In the following, the configuration of one of two cylinders will be described. An exemplary configuration of a saddle type vehicle in which the engine 1 may be mounted will be described below.

The engine 1 includes a cylinder block 10, a cylinder head 20, and a spark plug 30.

The cylinder head 10 includes a cylinder 11 that houses a piston 12. The cylinder block 10 defines one portion of the casing 2 of the engine 1. Further, in FIG. 1, components below the cylinder head 30 (including the cylinder 11 and the piston 12) are represented schematically.

The cylinder head 20 is coupled onto a cylinder block 10. The cylinder head 20 defines one portion of the casing 2 of the engine 1.

The cylinder head 20 includes a domed recess 20a. The cylinder head 20 covers the top portion of the cylinder 11 so that the recess 20a communicates with the cylinder 11. The cylinder head 20 defines the combustion chamber 11S along with the cylinder 11 and the piston 12, with the inner periphery of the recess 20a, the inner periphery of the cylinder 11, and the top surface of the piston 12 defining the combustion chamber 11S. The reciprocating motion of the piston 12 inside the cylinder 11 rotates a crankshaft (not shown).

The cylinder head 20 includes an intake port 21, exhaust ports 22, a spark plug hole 23, a drainage hole 24, and a water jacket 25.

The intake port 21 extends to the combustion chamber 11S. The intake port 21 introduces intake air (namely mixed air) into the chamber 11S. Although not shown, the intake port 21 is bifurcated downstream. The intake port 21 includes an entrance 21S that extends to an intake pipe. Although not shown, the intake port 21 includes an exit that opens to the recess 20a, and an intake valve is arranged at the exit.

The exhaust ports 22 include a first exhaust port 22a and a second exhaust port 22b. The first exhaust port 22a and the second exhaust port 22b each extends from the combustion chamber 11S. The first exhaust port 22a and the second exhaust port 22b each expel exhaust air from the combustion chamber 11S. The first exhaust port 22a and the second exhaust port 22b join together downstream into a single port. Although not shown, exhaust port 22 includes an inlet that opens to the recess 20a, and an exhaust valve is arranged at the inlet. The exhaust port 22 includes an exit 22S extending to an exhaust pipe. The exit 22S opens to the outer surface of the cylinder head 20. The exit 22S preferably has the shape of a circle with a center point 22P as the center.

The spark plug hole 23 houses the spark plug 30. The spark plug hole 23 extends to the combustion chamber 11S. The spark plug hole 23 is arranged between the intake port 21 and the exhaust port 22. The spark plug hole 23 includes a screw hole (mounting hole portion) 23a, a flange insertion portion 23b, a housing 23c, and an approach portion 23d. The screw hole 23a, the flange insertion portion 23b, the housing 23c, and the approach portion 23d are arranged to extend in that order from the combustion chamber 11S along the central axis 23AX of the spark plug hole 23. The screw hole 23a, the flange insertion portion 23b, the housing 23c, and the approach portion 23d preferably have increasing inner diameters in this order. The screw hole 23a of the spark plug hole 23 opens to the central portion of the recess 20a. As illustrated in FIG. 1, in the present preferred embodiment, the central axis 23AX is perpendicular or substantially perpendicular to the vehicle width direction of the saddle type vehicle, and tilted forward by approximately 20°, for example.

The spark plug 30 includes a screw (thread reach portion) 30a, a flange 30b, insulation 30c, and a hex 30d. The spark plug 30 is preferably a general type spark plug as defined by Japanese Industrial Standards (JIS) with screw threads on the outer periphery spanning almost the entire thread reach portion (from the underside of the flange 30b to the tip end surface of the portion from which the electrode protrudes) in the axial direction constituting the screw 30a. The spark plug 30 is a so-called long-reach portion spark plug with a longer screw portion than the length of the screw portion as defined in the JIS. In the present preferred embodiment, the screw diameter preferably is about 10 mm, for example, the distance between parallel sides of the hex preferably is about 14 mm, for example, and the length of the thread reach portion (from the underside of the flange 30b to the tip end surface from which the electrode protrudes) preferably is about 26.5 mm, for example.

The screw hole 23a extends to the combustion chamber 11S. The screw 30a of the spark plug 30 is screwed into the screw hole 23a. The length H of the screw hole 23a in a direction parallel or substantially parallel to the central axis 23AX (referred to below as the “central axis direction”) is no less than two times the inner diameter W of the screw hole 23a in the direction perpendicular or substantially perpendicular to the central axis direction (referred to below as “the radial direction”). In this manner, the screw hole 23a is thin and long depending on the shape of the screw 30a on the spark plug 30. The flange insertion portion 23b extends to the screw hole 23a. The flange 30b of the spark plug 30 is inserted into the flange insertion portion 23b. The underside of the flange 30b presses a gasket 30a onto the bottom surface of the flange insertion portion 23b. The flange insertion portion 23b is preferably shorter than the length H of the screw hole 23a. The inner diameter of the flange insertion portion 23b is preferably larger than the inner diameter W of the screw hole 23a.

The housing 23c extends to the flange insertion portion. The insulation 30c of the spark plug 30 is housed in the housing 23c. The housing 23c is longer than the length H of the screw hole 23a. The inner diameter of the housing 23c is larger than the inner diameter of the flange insertion portion 23b.

The approach portion 23d is between the housing 23c and the top surface of the cylinder head 20. The approach portion 23d is a passage that allows the spark plug to pass through when the spark plug is being inserted or removed.

The drainage hole 24 extends from the spark plug hole 23. The drainage hole 24 is configured to discharge moisture to the outside that has entered the spark plug hole 23. The drainage hole 24 extends between the first exhaust port 22a and the second exhaust port 22b as illustrated in FIG. 2. The drainage hole 24 is preferably a straight line along a centerline 24P. The centerline 24P intersects with the central axis 23AX of the spark plug hole 23. The centerline 24P is inclined preferably by about 28°, for example, in relation to an axis perpendicular or substantially perpendicular to the central axis 23AX (and about 62°, for example, in relation to the central axis 23AX). Further, setting the central axis 23AX to be inclined preferably by about 20°, for example, in relation to the vertical axis results in the centerline 24P being inclined with respect to the horizontal axis preferably by about 48°, for example.

The drainage hole 24 includes an inlet 24a and an outlet 24b. The drainage hole 24 is located between the first exhaust port 22a and the second exhaust port 22b. The inlet 24a is located in the flange insertion portion 23b of the spark plug hole 23. The inlet 24a opens to an inner surface 23b1 of the flange insertion portion 23b. The outlet 24b is arranged at the outer edge of the exit 22S of the exhaust port 22. The exit 22S opens to the outer surface of the cylinder head 20. The outlet 24b is located closer to the cylinder 11 than the center point 22P of the exit 22S in the central axis direction of the spark plug hole 23.

The water jacket 25 extends to a radiator (not shown). The water jacket 25 is a passage that circulates coolant that has been cooled by the radiator. The coolant flowing through the water jacket 25 cools the cylinder 11.

As illustrated in FIG. 3, the water jacket 25 preferably includes an outer annular passage 26 which, when viewed from the top, defines a figure-8 shape (that is, the shape of an infinity symbol in the figure) that surrounds each cylinder, and a linking passage 27 which communicates longitudinally in the center in the transverse direction. The water jacket 25 establishes a coolant flow from a coolant inlet 28 (the left side of FIG. 3) to a coolant outlet 29 (the right side of FIG. 3).

The water jacket 25 includes a central passage 25a, and inter-port passage 25b, a first outer passage 25c, and a second outer passage 25d.

The central passage 25a surrounds the entire perimeter of the spark plug hole 23. In the present preferred embodiment, each of the two cylinders is provided with a central passage 25a, and the central passages are connected. For the sake of convenience, the central passage 25a is classified as an exhaust-side central passage 25a1, or an intake-side central passage 25a2 in the explanation below. The exhaust-side central passage 25a1 is defined as the section closer to the exhaust port 22 than the central axis 23AX in the central passage 25a. The intake-side central passage 25a2 is defined as the section closer to the intake port 21 than the central axis 23AX in the central passage 25a. The central passage 25a defines one portion of the linking passage 27.

The exhaust-side central passage 25a1 is located between the flange insertion portion 23b and the cylinder 11 along the central axis direction of the spark plug hole 23 as illustrated in FIG. 1. The exhaust-side central passage 25a1 approaches the screw hole 23a of the spark plug hole 23. The distance between the exhaust-side central passage 25a1 and the central axis 23a is smaller than the distance between the inner surface 23b1 of the flange insertion portion 23b and the central axis 23AX in the radial direction of the central axis 23AX. The distance between the inner surface 23b1 of the flange insertion portion 23b and the central axis 23AX is equivalent to the radius of the flange insertion portion 23b. Therefore, the inner edge of the exhaust-side central passage 25a1 is closer to the central shaft 23AX than the inner edge of the drainage hole 24. The exhaust-side central passage 25a1 includes a recess 25S provided therein for the drainage hole 24 to pass through as illustrated in FIG. 2. The exhaust-side central passage 25a1 is adjacent to the screw hole 23a near the drainage hole 24, and adjacent to the screw hole 23a and the flange insertion portion 23b of the spark plug hole 23 at a location spaced away from the drainage hole 24 in the circumferential direction of the central axis 23AX.

The intake-side central passage 25a2 is located between the housing 23c and the cylinder 11 along the central axis direction of the spark plug hole 23 as illustrated in FIG. 1. The intake-side central passage 25a2 approaches the screw hole 23a of the spark plug hole 23 and the flange insertion portion 23b of the spark plug hole 23.

The inter-port passage 25b is located between the first exhaust port 22a and the second exhaust port 22b (between the exhaust ports). The inner edge of the inter-port passage 25b extends to the central passage 25a. The outer edge of the inter-port passage 25b extends from the first outer passage 25c. Coolant flows into the inter-port passage 25b from the first outer passage 25c toward the central passage 25a. As illustrated in FIG. 1, the inter-port passage 25b is located between the drainage hole 24 and the cylinder 11 along the central axis direction. Therefore, arranging the inter-port passage 25b adjacent to the cylinder 11 efficiently cools the cylinder 11. Additionally, the region between the exhaust ports is heated to a relatively high temperature due to the high-temperature exhaust gas flowing through the first exhaust port 22a and the second exhaust port 22b. Therefore, the coolant flowing in the inter-port passage 25b directly cools between the exhaust ports.

The first external outer passage 25c is located outside of the inter-port passage 25b. The first outer passage 25c extends to the outer edge of the inter-port passage 25b. The first outer passage 25c is located closer to the exit 22S of the exhaust port 22 than the inter-port passage 25b with the central axis 23AX as a reference point. That is, the first outer passage 25c is farther away from the central axis 23AX than the inter-port passage 25b. In the present preferred embodiment, each of the two cylinders is provided with a first outer passage 25c, and the first outer passages 25c are connected to each other. The first outer passage 25c defines one portion of the outer annular passage 26.

The second outer passage 25d is located closer to the entrance 21S of the intake port 21 than the central passage 25a with the central axis 23AX as a reference point. The second outer passage 25d does not extend directly to the central passage 25a. In the present preferred embodiment, each of the two cylinders is provided with a second outer passage 25d, and the second outer passages 25d are connected to each other. The second outer passage 25d defines one portion of the outer annular passage 26.

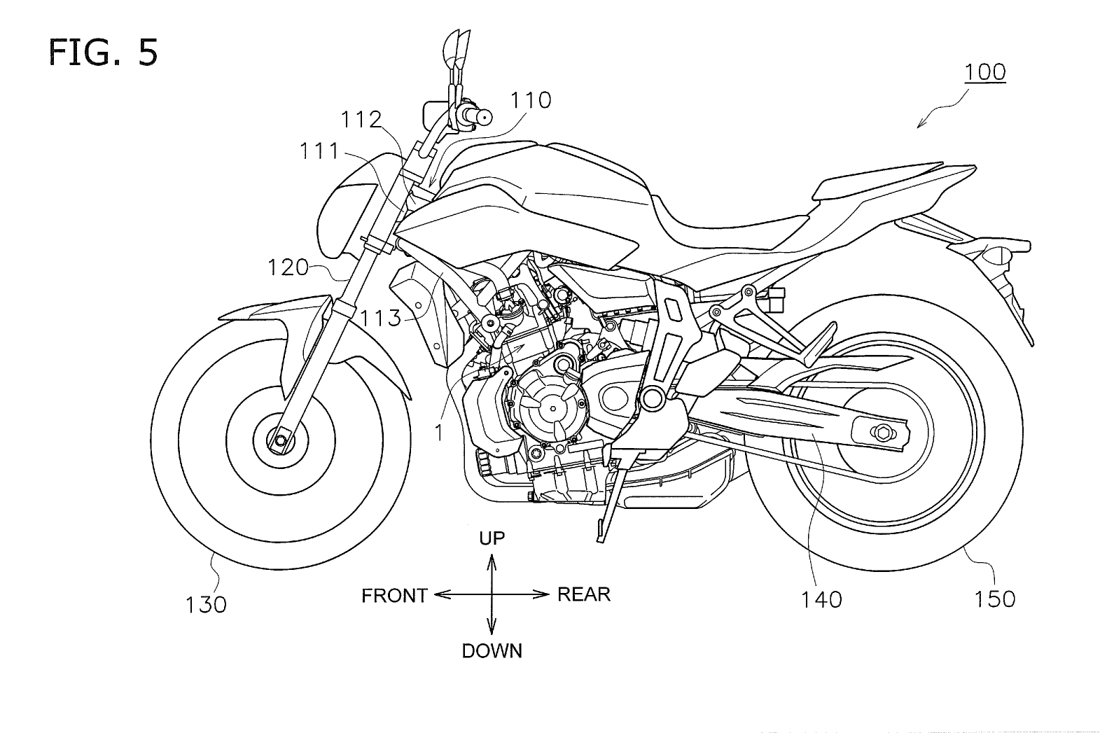

An overall configuration of a saddle type vehicle 100 in which the above-described engine 1 may be mounted will be described with reference to the drawings. FIG. 5 is a side view of a saddle type vehicle 100.

The saddle type vehicle 100 is a motorcycle, for example. As illustrated in FIG. 5, the saddle type vehicle 100 includes a frame 110, a front fork 120, a front wheel 130, a swingarm 140, a rear wheel 150, and the engine 1.

The frame 110 includes a head pipe 111, a front frame 112, and a pair of down tubes 113, 113. The head pipe 111 is arranged at the center of the vehicle in the vehicle width direction. The head pipe 111 extends vertically. The front frame 112 extends rearward and downward from the head pipe 111. The front frame 112 is arranged so as to extend above and behind the engine 1. The engine 1 is coupled at the lower end portion of the front frame 112. The pair of down tubes 113, 113 is connected to the head pipe 111 below the front frame 112. The pair of down tubes 113, 113 each extend rearward and downward from the head pipe 111 and extend away from each other. The rear end portions of the pair of down tubes 113, 113 are each connected to the front portion of the engine 1.

The front fork 120 is rotatably supported by the head pipe 111. The front wheel 130 is rotatably supported at the lower end portion of the front fork 120.

The swing arm 140 is pivotally supported on the lower end portion of the front frame 112. The rear wheel 150 is rotatably supported at the rear end portion of the swingarm 140.

The engine 1 is supported by the lower end portion of the front frame 112 and the rear end portion of each of the pair of down tubes 113, 113.

A cylinder head 20 in an engine 1 according to the present preferred embodiment includes a spark plug hole 23 that extends to a combustion chamber 11S of a cylinder 11, a drainage hole 24 that extends to the spark plug hole 23, and a water jacket 25. The water jacket 25 includes a central passage 25a located near the plughole 23, and an inter-port passage 25b arranged between a first exhaust port 22a and a second port 22b. The inter-port passage 25b is located between the drainage hole 24 and the cylinder 11 along a central axis direction of the spark plug hole.

Accordingly, the drainage hole 24 and the inter-port passage 25b are compactly arranged while obtaining effective cooling of the cylinder 11 by providing the inter-port passage 25b between first exhaust port 22a and the second exhaust passage 22b.

Further, given that the inter-port passage 25b is connected to the central passage 25a, it is possible to prevent air from collecting in the inter-port passage 25b. For example, if the inter-port passage 25b is not connected to the central passage 25a, any air mixed into the water jacket 25 will collect at the end portion of the inter-port passage 25b during exchange of the coolant. According to the present preferred embodiment, the inter-port passage 25b is connected to the central passage 25a, and therefore it is possible to prevent air from collecting in the inter-port passage 25b. Consequently, the efficiency of cooling the cylinder is improved.

The central passage 25a is located adjacent to the screw hole 23a of the spark plug hole 23.

In this manner, the central passage 25a is located adjacent to the spark plug hole 23 at the section closest to the cylinder 11, thus further improving the efficiency of cooling the cylinder 11.

The inter-port passage 25b is located between the flange insertion portion 23b and the cylinder 11 along the central axis direction.

Accordingly, the inter-port passage 25b is brought even closer to the cylinder, thus improving the efficiency of cooling the cylinder.

The distance between the central passage 25a (more specifically, the exhaust-side central passage 25a1) and the central axis 23a is smaller than the distance between the inner surface 23b1 of the flange insertion portion 23b and the central axis 23AX in the radial direction of the central axis 23AX.

In this manner, extending the central passage 25a up to near the center of the cylinder 11 further improves the efficiency of cooling the cylinder 11.

The water jacket 25 includes the first outer passage 25c which extends to the outer edge of the inter-port passage 25b.

Accordingly, the inter-port passage 25b communicates with the central passage 25a and the first outer passage 25c, and therefore it is possible to prevent air from collecting in the inter-port passage 25b.

The drainage hole 24 extends between the first exhaust port 22a and the second exhaust port 22b.

Accordingly the drainage hole 24 and the inter-port passage 25b are arranged side-by-side between the first exhaust port 22a and the second exhaust passage 22b, thus bringing the inter-port passage 25b closer to the cylinder 11 to improve the efficiency of cooling the cylinder.

The drainage hole 24 includes an inlet 24a provided in the flange insertion portion 23b of the spark plug hole 23.

Accordingly, moisture is efficiently drained from the locations in the spark plug hole 23 where moisture especially tends to collect.

The drainage hole 24 includes the outlet 24b located closer to the cylinder 11 than the center point 22P of the exit 22S of the exhaust port 22 in the central axis direction of the spark plug hole 23.

Accordingly, when viewed from the side, the drainage hole 24 appears to intersect with the exhaust port 22, and therefore the drainage hole 24 is more compactly arranged.

The length H of the screw hole 23a is no less than two times the inner diameter W of the screw hole 23a.

Accordingly, a large amount of space may be secured for the central passage 25a and the inter-port passage 25b, and therefore the central passage 25a and the inter-port passage 25b have large inner diameters. Therefore, the efficiency of cooling the cylinder 11 is improved.

On the one hand, the area for arranging the outer periphery of the central passage 25a is restricted by the intake port 21 and the exhaust port 22, while the area for arranging the inner periphery thereof is restricted by the spark plug hole 23 (flange 23b). If, as in the present preferred embodiment, the length H of the screw hole 23a is about 26.5 mm, for example, then the smaller diameter screw hole 23a will extend vertically compared to the other sections of the spark plug hole 23, and therefore it is possible to expand the central passage 25a vertically and in the inner circumferential direction. Additionally, it is also possible to arrange the drainage hole 24 and the inter-port passage 25b adjacent to each other.

The central passage 25a surrounds the entire perimeter of the spark plug hole 23.

Therefore, the efficiency of cooling the cylinder is improved.

### Other Preferred Embodiments

While the present invention has been described by way of the above-mentioned preferred embodiments, the statements and drawings which are one portion of this disclosure should not be taken as limitations on the present invention. Various substitute preferred embodiments, working examples, and practical features should be clear to persons skilled in the art from this description.

In the above mentioned preferred embodiments, the engine 1 is preferably a four-valve DOHC two-cylinder four-stroke engine, for example. However, the technology disclosed herein is not limited to this type of engine. The engine 1 may include a plurality of exhaust valves for each cylinder. For example, if one cylinder in the engine 1 includes three exhaust valves, then the water jacket 25 may include two inter-port passages 25b between each of the three valves.

In the above mentioned preferred embodiments, the centerline 24P of the drainage hole 24 is arranged linearly to intersect with the central axis 23AX of the spark plug hole 23, however, the present invention is not limited to this configuration. The centerline 24P of the drainage hole 24 need not intersect with the centerline 23P of the spark plug hole 23. Furthermore, at least one portion of the drainage hole 24 may be curved.

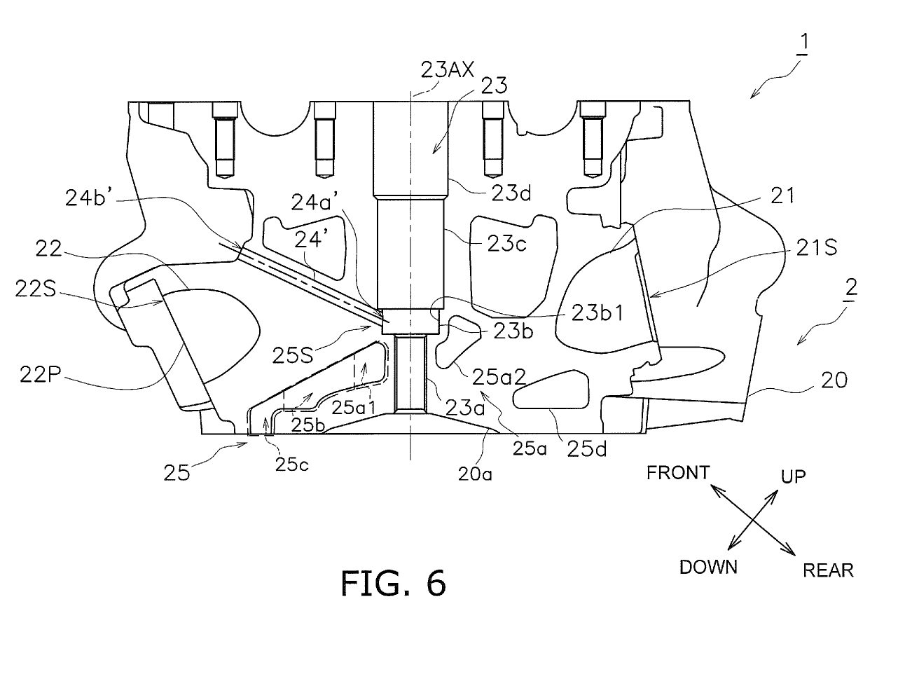

In the above mentioned preferred embodiments, the drainage hole 24 passes between the first exhaust port 22a and the second exhaust port 22b, however the present invention is not limited to this configuration. It is sufficient for the drainage hole 24 to pass over the inter-port passage 25b, and as illustrated in FIG. 6, the drainage hole 24 may extend gradually away from the cylinder 11. When the drainage hole 24 extends gradually away from the cylinder 11, the outlet 24b′ of this drainage hole 24′ is further away from the cylinder 11 than the exit 22S of the exhaust port 22 in the central axis direction. Moreover the drainage hole 24′ provides satisfactory drainage so long as the inlet 24a′ is above the outlet 24b′ when the engine 1 is mounted to the vehicle.

In the above mentioned preferred embodiments, the inlets 24a of the drainage hole 24 preferably open into the sidewall of the flange insertion portion 23b, however the present invention is not limited to this configuration. The inlet 24a may open into the inner wall of the spark plug hole 23. For example, the inlet 24a may open into the bottom surface of the flange insertion portion 23b.

In the above-mentioned preferred embodiments, the exhaust-side central passage 25a1 and the intake-side central passage 25a2 communicate with each other, and the central passage 25a surrounds the entire perimeter of the spark plug hole 23, however the present invention is not limited to this configuration. It is sufficient for the inter-port passage 25b to extend to the exhaust-side central passage 25a1.

In the above-mentioned preferred embodiments, a so-called JIS general type spark plug including a screw 30a is preferably used, however, a so-called JIS half thread spark plug may also be used, where on the outer periphery of the thread reach portion the screw threads are provided near just the electrode while near the flange is straight. Additionally, for example, it is preferable if a JIS spark plug with a reach portion of approximately 26.5 mm, for example, is used because there is some excess thickness near the center in the vertical direction; further, it is even more preferable if a JIS spark plug with a small screw diameter (about 10 mm, or about 12 mm, for example) is used, given that there is some excess space near the center.

Finally a spark plug with a tapered flange 30b may be used without providing a gasket 30e at the seal portion (below the flange).

In the above-mentioned preferred embodiments, the central passage 25a preferably surrounds the entire perimeter of the spark plug hole 23, however the central passage 25a may be C-shaped or may be segmented. Additionally in the above-mentioned preferred embodiments, the water jacket 25 preferably includes an outer annular passage 26 which, when viewed from the top, defines a figure-8 shape that surrounds each cylinder, and a linking passage 27 which communicates longitudinally in the center in the transverse direction; the arrangement may be modified, and each passage may use another shape. As long as the arrangement relationship between the central passage 25a and the first outer passage 25c is maintained, a modified configuration may be used in the present invention.

In should be clear that the present invention may include various preferred embodiments and so forth that are not described here. Accordingly, the technical scope of the present invention is defined by the characterizing features of the present invention as set forth in the scope of the claims which are supported by the above description.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An engine comprising:
a piston; and
a casing including a cylinder, the cylinder housing the piston, and the cylinder and the piston define a combustion chamber; wherein
the casing includes an intake port, a plurality of exhaust ports, a spark plug hole, a drainage hole, and a water jacket;
the intake port extends to the combustion chamber and is configured such that intake air is introduced into the combustion chamber through the intake port;
the plurality of exhaust ports extend from the combustion chamber and is configured such that exhaust air is expelled from the combustion chamber through the plurality of exhaust ports;
the spark plug hole extends to the combustion chamber, and the spark plug is housed in the spark plug hole;
the drainage hole extends from the spark plug hole;
the water jacket is configured to circulate coolant therein;
the water jacket includes a central passage and an inter-port passage;
the central passage is located adjacent to the spark plug hole;
the inter-port passage extends to the central passage and is arranged between the plurality of exhaust ports; and
the inter-port passage is located between the drainage hole and the cylinder in a central axis direction of the spark plug hole.

2. The engine according to claim 1, wherein the spark plug includes a reach portion, and the reach portion includes a screw thread provided on at least one portion of an outer peripheral surface of the reach portion;
the spark plug hole includes a mounting hole portion extending to the combustion chamber, and the reach portion of the spark plug is threaded on at least one portion of an inner surface of the mounting hole portion; and
the central passage is located adjacent to the mounting hole portion of the spark plug hole.

3. The engine according to claim 2, wherein the spark plug hole includes a flange insertion portion extending to the mounting hole portion, and a flange of the spark plug is inserted in the flange insertion portion; and
the inter-port passage is located between the flange insertion portion and the cylinder in the central axis direction.

4. The engine according to claim 3, wherein a distance between the central passage and the central axis is smaller than a distance between an inner surface of the flange insertion portion and the central axis in a radial direction perpendicular or substantially perpendicular to the central axis.

5. The engine according to claim 1, wherein the water jacket includes an outer passage extending to the inter-port passage, and the outer passage is located farther away from the central axis than the inter-port passage in the radial direction perpendicular to the central axis.

6. The engine according to claim 1, wherein the drainage hole extends between the plurality of exhaust ports.

7. The engine according to claim 6, wherein the spark plug hole includes a flange insertion portion extending to the mounting hole portion, and a flange of the spark plug is inserted in the flange insertion portion; and
the drainage hole includes an inlet provided in the flange insertion portion of the spark plug hole.

8. The engine according to claim 6, wherein the drainage hole includes an outlet located closer to the cylinder than a center position of an exit of the plurality of exhaust ports in the central axis direction.

9. The engine according to claim 1, wherein a length of the mounting hole portion is no less than two times an inner diameter of the mounting hole portion.

10. The engine according to claim 1, wherein the central passage surrounds an entire perimeter of the spark plug hole.

11. The engine according to claim 1, wherein the inter-port passage overlaps with the drainage hole when viewed from a top of the engine.

12. A saddle type vehicle comprising:
an engine according to claim 1.

13. The engine according to claim 3, wherein the drainage hole extends between the plurality of exhaust ports.

14. The engine according to claim 13, wherein the drainage hole includes an inlet provided in the flange insertion portion of the spark plug hole.

15. The engine according to claim 13, wherein the drainage hole includes an outlet located closer to the cylinder than a center position of an exit of the plurality of exhaust ports in the central axis direction.
